(19) United States
(12) Patent Application Publication
(10) Pub. No.: US 2007/0279697 A1
(43) Pub. Date: Dec. 6, 2007

(54) Security element for a data carrier, data carrier comprising such a security element, semifinished product for producing a data carrier, and method for producing a data carrier

(75) Inventors: Heidi Widmer Gomres, Toffen (CH); Stephan Hofstetter, Niedererlinsbach (CH); Paul Christen, Aarau (CH)

Correspondence Address: THE WEBB LAW FIRM, P.C., 700 KOPPERS BUILDING, 436 SEVENTH AVENUE, PITTSBURGH, PA, 15219, US

(73) Assignee: TRUB AG, Aarau (CH)

(21) Appl. No.: 11/784,197

(22) Filed: Apr. 5, 2007

(30) Foreign Application Priority Data
Apr. 12, 2006 (EP) 06 405 159.2

(51) Int. Cl. B41M 3/14; H04L 9/00

(52) U.S. Cl. 358/3.28; 235/454; 283/88; 382/100; 382/115; 705/62

(57) ABSTRACT

The security element has a pattern, and in particular a Moiré pattern which contains a coded pattern or image which is made visible through a filter. The filter is arranged on a layer that is fixedly connected to a substrate, a distance of at least 0.025 mm being present between the pattern and the filter. When the security element is tilted, the pattern or the image moves continuously. The pattern is preferably a band Moiré pattern. The filter is preferably a line filter that is laser-transmissive. The pattern is preferably produced through the filter by means of a laser. The security element according to the invention is distinguished by high security against forgery and can nevertheless be produced in a comparatively cost-effective manner.

The invention relates to a security element for a data carrier, in particular payment, authorization or identification document, comprising a substrate, on which is arranged at least one Moiré pattern containing a coded pattern or image which is visible through a filter. The invention additionally relates to a data carrier comprising such a security element, a semifinished product for producing a data carrier, and a method for producing a data carrier.

Security elements are known in the case of credit or identification cards, for example and serve for securing the latter against forgery or imitation or manipulation. Since, as is known, forgery methods are constantly improving, however, it is necessary to provide new security elements which make forgery more difficult. Such security elements should be formed in such a way that they are suitable for series production and do not adversely affect the requirements made of the use properties of the data carrier.

WO 2004/036507 and WO 2006/006063 have disclosed security elements in which a Moiré pattern is arranged in the document. Said pattern is generated by a computer program and does not reveal any image to the naked eye. The pattern contains a concealed image, however, which can be discerned if a film containing a specific filter is placed on the Moiré pattern. By moving the film in an intended direction, the image that can then be discerned moves correspondingly continuously. Different optical effects are possible depending on the formation of the Moiré pattern and film. By way of example, the abovementioned prior art describes an embodiment in which objects of an image move in different directions. An optically fluid transition from an image A to an image B or a colour change is also possible. Finally, a flip effect from an image A to an image B and further to an image C, etc. is also possible. Forgery is particularly difficult in this case since such Moiré patterns, and in particular band Moiré patterns, and corresponding filters necessitate very precise production and even slight manipulations alter or destroy the effect mentioned.

The security element according to the invention provides for the filter to be arranged on a layer that is fixedly connected to the substrate, a fixed and specific distance being present between the Moiré pattern and the filter. Consequently, in the case of the security element according to the invention, the filter is fixedly connected to the Moiré pattern and therefore cannot be displaced. In contrast to the abovementioned prior art, a concealed image is therefore visually discernable even without an additional film. The optical effect achieved is likewise completely different. The movement of the image is not effected by movement of the filter, but rather by tilting of the security element or of the data carrier in which the security element is integrated. The abovementioned specific distance between the Moiré pattern and the filter is essential. In the course of tilting, the image moves continuously and not in stepped fashion. The pattern is introduced as whole and is not composed of individual images, as is the case with customary so-called flip images. In the case of the subject matter of the invention, however, it is possible to combine two or more patterns or band Moiré patterns. Such flip images are known for example in the case of greetings cards for children and are disclosed for example in U.S. Pat. No. 6,288,842 and EP 1 168 060 A.

In the case of the security element according to the invention, the said distance is determined by the thickness of the said layer. The layer may be formed by one film or by a plurality of films. The layer is preferably transparent. The greater the distance between the Moiré pattern and the filter, or the finer the reproduction, then the greater the visible movement of the image and the greater the complexity of images possible. The movement of the image arises here not as a result of a displacement of the abovementioned film, but rather as a result of different viewing angles with respect to the surface of the abovementioned layer.

The substrate is connected to the said layer preferably by means of lamination. The Moiré pattern is preferably printed onto the substrate. The filter may likewise be printed on, to be precise in particular onto the top side of the said layer. By way of example and in particular screen printing or offset printing is suitable as printing method.

In accordance with one development of the invention, the said filter is a line filter, which is preferably printed onto the said layer. Such a line filter can be produced very cost-effectively in series. It has the advantage, moreover, that it does not alter the surface structure and a planar surface is therefore possible. The period of the line filter differs from the period of the pattern or Moiré pattern; it can be either larger or smaller. A line filter can be produced very cost-effectively and enables the pattern to be produced by means of a laser beam through said filter with constant angle of incidence on the substrate. The pattern may be a pattern of the kind that is customary in flip images, or a Moiré pattern or a band Moiré pattern. In this case, the substrate comprises a laserable material. It has been shown that a very high opacity of the non-transparent parts of this filter is particularly advantageous in this case. Black, grey or white filters are preferably used. However, other filter colours are also conceivable. A polarization filter is also possible.

According to one development of the invention, the Moiré pattern is produced by means of a laser after the substrate has been connected to the layer. This enables a personalization by corresponding formation of the pattern. An individual pattern can thus be generated for each individual security element. For this purpose, the filter is applied to the layer, for example is printed onto the said layer as mentioned above. In this case, the said filter is formed in such a way that it is laser-transmissive. The same applies to the material of the layer. Consequently, in this case the said layer is not only transparent, but also transmissive to laser beams. A laserable material is arranged below the laser-transmissive transparent layer which material changes colour upon impingement of the laser beams and the pattern can thereby be formed. As already mentioned, the said pattern or Moiré pattern can be personalized in this case. In principle, the same movement sequences as mentioned above are possible in the case of this embodiment. On account of the comparatively low resolution of laser apparatuses, the best effect is achieved by means of a tilting movement. It is advantageous, moreover, that a continuous movement or a flip effect of two or more patterns can be achieved without the angle of incidence of the laser beam on the substrate having to be changed. The said movement sequences or a continuous movement or a flip effect are achieved without having to use a lens grid such as is described in EP 0 219 012.

According to one development of the invention, the filter is formed by a lens grid, which can be produced for example by an embossing method on the top side of the said layer. The lens structure of the said filter likewise has the said distance from the pattern arranged in the interior of the security element. The lens structure acts as a filter which reveals the said concealed image of the pattern, with the result that it is visually directly visible. In this case, too, the image moves continuously if the security element is tilted. However, it is also possible to combine two or more band Moiré patterns. The lens structure may be applied either directly during lamination or in a subsequent embossing method.

A particularly high security against forgery can be achieved when the pattern is a Moiré pattern, and in particular a band Moiré pattern.

Further advantageous features emerge from the dependent patent claims, the description below, and the drawing.

Exemplary embodiments of the invention are explained in more detail below with reference to the drawing, in which:

FIG. 1 schematically shows a section through a data carrier with a security element according to the invention,

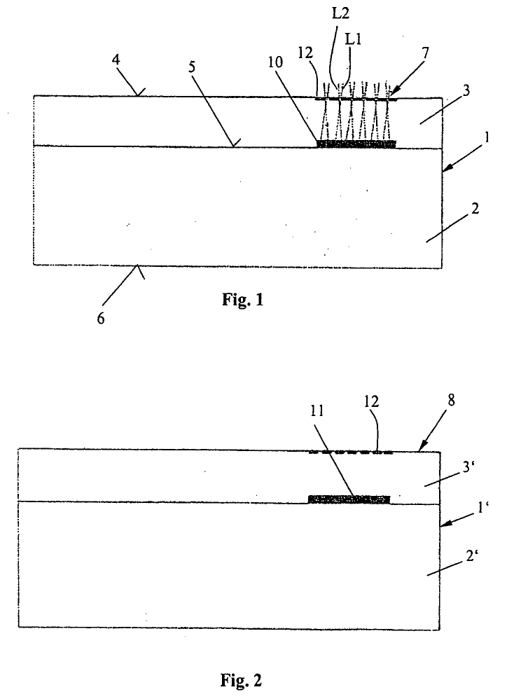

FIG. 2 schematically shows a section through a data carrier with a security element in accordance with one variant,

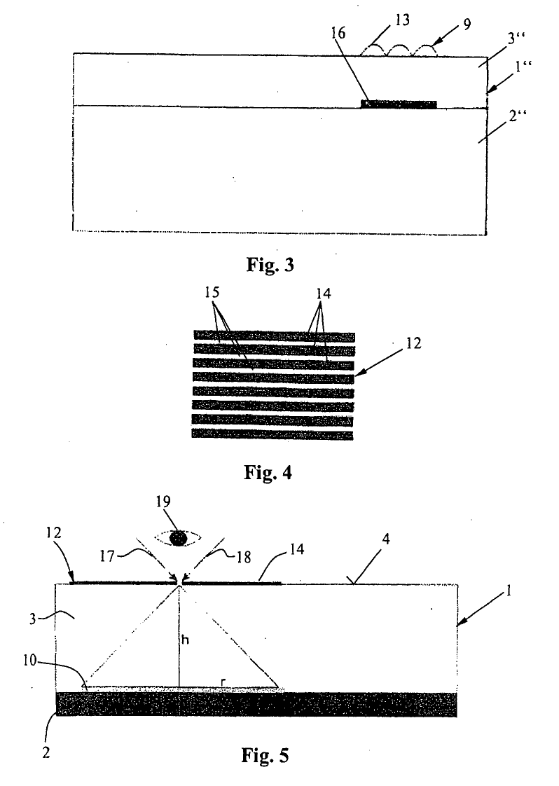

FIG. 3 schematically shows a section through a data carrier with a security element in accordance with a further variant,

FIG. 4 shows a plan view of a line filter, and

FIG. 5 schematically shows a section through a security element for illustrating the relationship between the Moiré resolution and the distance between the filter and the band Moiré pattern.

FIG. 1 schematically shows a data carrier 1, which is for example a credit or identification card, an identity card or a so-called data page in a passport or some other document. The data carrier 1 has a substrate 2, which is for example a film composed of plastic, for example polycarbonate, or some other suitable material. A layer 3 is connected to the substrate 2, for example by the layer 3 being laminated onto the substrate 2. The layer 3 is fixedly and preferably inseparably connected to the substrate 2. The layer 3 may likewise be in monolayer or multilayer form. It is transparent at least in the region of a security element 7. The layer 3 has a top side 4, to which can be applied, in principle, a further transparent layer or a transparent lacquer or the like (not shown here). The said top side 4 is preferably parallel to an underside 6 of the substrate 2.

The security element 7 comprises a band Moiré pattern 10 or a customary Moiré pattern, which is arranged on a top side 5 of the substrate 2 or at an underside of the layer 3, and a filter 12, which is a line filter, in particular. The filter 12 is arranged at a distance from the band Moiré pattern 10 above the latter, as shown in FIG. 1. In accordance with FIG. 4, it comprises opaque lines 14 and transparent likewise linear parts 15. The opaque lines 14 have a comparatively very high opacity and are applied on the top side 4, for example by means of an analogue printing method, in particular screen printing or offset printing, or for example a digital printing method. The lines may also be inserted as additional elements between the substrate 2 and the layer 3. In accordance with FIG. 4, the opaque parts 14 and the transparent parts 15 may be straight parts that are parallel to one another, but they may also be formed as other forms that can be described mathematically, such as, for example, circles or spirals or wavy lines. The distances between the opaque parts 14 of the filter are identical in this case, however.

The band Moiré pattern 10 is printed onto the top side 5 of the substrate or is printed onto the underside 6 of the layer 3 or is inserted between the substrate 2 and the layer 3. For disclosure with regard to the formation and production of the band Moiré pattern, reference is made to the said two documents. In the case of the present invention, however, the said band Moiré pattern 10 is not viewed through an applied film, but rather through the filter arranged fixedly and at a distance with respect to the band Moiré pattern 10. The band Moiré pattern 10 contains an image or a subject which is inherently concealed and becomes visible through the filter 12. If the data carrier 1 is tilted, then the said image moves continuously. By way of example, the data carrier 1 may be tilted in such a way that the viewing direction changes from line L1 to line L2. Upon viewing in the direction of line L1, for example an image A (not shown here) becomes visible here, while upon viewing in the direction of line L2, an image B (not shown here) is visible. Upon changing from one direction to the other, the pattern moves continuously from the position A to the position B. The optical effect thus differs significantly from the flip effect known per se, in which either an image A or an image B is visible. Consequently, upon tilting, a fluid or continuous transition takes place in the case of the security element 7. In order for this to be possible, the arrangements shown in FIG. 5 are necessary. In the case of a viewing angle of 90°, which is indicated by the two arrows 17 and 18 in FIG. 5, a third of a Moiré tile period should be visible to a viewer 19. In this case, the said third corresponds to 2r and the Moiré tile period corresponds to 6r. A third is a guide value in this case since the optical effect is also dependent on the Moiré design. The distance h between the band Moiré pattern 10 and the filter 12 is also significant. If the said distance h is 0.1 mm, then it is equal to 0.1 mm. Since it is a sixth of the baseband period, the baseband period here is therefore at most 0.6 mm in order to obtain a good optical effect. The baseband period (also called Moiré tile period) denotes the height of the patterns repeating in a band Moiré pattern. A band Moiré pattern image comprises repeating identical patterns. The smaller the distance h, the finer the band Moiré pattern 10 should be in order to obtain a satisfactory optical effect. The distance h is at least 0.025 mm and preferably at least 0.05 mm. Preferably, the distance h is 0.1 mm or greater.

FIG. 2 shows a data carrier 1′, likewise having a substrate 2′ and a layer 3′. The layer 3′ is likewise fixedly connected to the substrate 2′, for example by lamination. The filter 12 may be formed in a manner identical to that mentioned above. The filter 12 is here in particular also a line filter, which was applied to the layer 3′ by means of a screen printing or offset printing method, by way of example. The data carrier 1′ has a security element 8 provided with a band Moiré pattern 11, which was produced by means of a laser only subsequently after the connection of the later 3′ to the substrate 2′. In order that the band Moiré pattern 11 can be produced by means of a laser, the filter 12 is formed in such a way that it is laser-transmissive. This likewise applies to the layer 3′. The substrate 2′ is produced from a laserable material. Such materials are known per se and become discoloured upon the impingement of laser beams. For this security element, the effect and the conditions are similar or identical to those explained above with reference to FIGS. 1 and 5. An essential advantage of this security element 8 is that the latter can be produced individually and on a personal basis. The band Moiré pattern 11 may contain for example an identification number or some other personal indication of the owner of the data carrier 1′. The band Moiré pattern 11 is preferably not produced until when the data carrier 1′ is personalized. At the same time, further data may also be applied outside the security element 8, for example may be printed on or likewise applied by means of a laser. Consequently, the data carrier 1′ is first produced only with the filter 12. Consequently, a semifinished product is produced which does not yet contain the band Moiré pattern 11. The said semifinished product can be stored until the data carrier 1′ is personalized and, in particular, the band Moiré pattern 11 is created by means of a suitable laser apparatus in the manner mentioned.

FIG. 3 shows a data carrier 1″ having a substrate 2″ and a layer 3″. The data carrier 1″ is provided with a security element 9 comprising a band Moiré pattern 16 and a filter 13. The band Moiré pattern 16 may be formed identically to the pattern 10 or 11 and is therefore likewise integrated into the data carrier 1″. The layer 3″ is likewise transparent and may be in monolayer or multilayer form. The filter 13 in this case is formed as a lens structure. The latter may be embossed onto the top side of the layer 3″ either directly during the lamination of the layer 3″ or in a subsequent embossing method. As can be seen, the filter 13 is applied to a partial region of the top side of the layer 3″, to be precise above the band Moiré pattern 16. Consequently, the filter 13 does not extend over the entire top side as is the case for the known flip images. In this case, too, the filter 13 is integrated directly into the data carrier 1″. In this case, too, a fluid movement of an image becomes visible when the data carrier 1″ is tilted. Here, too, the conditions are essentially identical to those explained above with reference to FIGS. 1 and 5.

### LIST OF REFERENCE SYMBOLS

1 Data carrier
2 Substrate
3 Layer
4 Top side
5 Top side (substrate)
6 Underside (substrate)
7 Security element
8 Security element
9 Security element
10 Moiré pattern
11 Moiré pattern
12 Line filter
13 Lens grid
14 Opaque part
15 Transparent part
16 Moiré pattern
17 Arrow
18 Arrow
19 Viewer
h Distance
r Half visible part of the Moiré tile period
L1 Line
L2 Line

1-23. (canceled)

24. A security element for a data carrier, wherein the data carrier is a payment, authorization or identification document, wherein the security element comprises a substrate having at least one pattern arranged thereon, wherein the pattern is visible through a filter, wherein the filter is arranged on a layer that is fixedly connected to the substrate, and wherein the pattern is at a distance of at least 0.025 mm from the filter.

25. The security element according to claim 24, wherein the distance between the pattern and the filter is at least 0.05 mm.

26. The security element according to claim 24, wherein the distance is at least 0.025 mm and at most 1 mm.

27. The security element according to claim 24, wherein the filter is arranged on a top side of the layer.

28. The security element according to claim 24, wherein the filter is formed as a line grid.

29. The security element according to claim 24, wherein the filter is formed by a lens structure.

30. The security element according to claim 29, wherein the lens structure is embossed.

31. The security element according to claim 24, wherein the filter is printed onto the layer.

32. The security element according to claim 31, wherein the filter is applied onto the layer in:
an analogue printing method, including a screen printing method or an offset printing method; or
a digital printing method, including a thermoprinting method or a digitally printing method.

33. The security element according to claim 31, wherein the filter is a line filter, wherein opaque parts thereof have a substantially high opacity.

34. The security element according to claim 24, wherein the pattern is a Moiré pattern applied to a top side of the substrate or to an underside of the layer via an analogue or digital printing method.

35. The security element according to claim 24, wherein the pattern is produced by a laser.

36. The security element according to claim 35, wherein the filter is laser-transmissive.

37. The security element according to claim 35, wherein the pattern contains an individual part for a personalization.

38. The security element according to claim 24, wherein the filter is a polarization filter.

39. The security element according to claim 24, wherein the pattern is a band Moiré pattern.

40. The security element according to claim 24, wherein the pattern is inserted as an additional element between two layers.

41. A data carrier comprising:
a security element comprising a substrate having at least one pattern arranged thereon, wherein the pattern is visible through a filter, wherein the filter is arranged on a layer that is fixedly connected to the substrate, and wherein the pattern is at a distance of at least 0.025 mm from the filter; and
a body formed essentially by the substrate and the layer.

42. The data carrier according to claim 41, wherein the data carrier is a payment, authorization or identification card or a data page in a passport.

43. A method for producing a data carrier having a security element, the method comprising the steps of:
providing a substrate;
arranging a filter on a layer that is fixedly connected to the substrate, wherein the filter is laser-transmissive; and
producing at least one pattern through the filter by a laser, wherein the at least one pattern is produced on the substrate, wherein the pattern is visible through the filter, and wherein the pattern is at a distance of at least 0.025 mm from the filter.

44. The method according to claim 43, wherein the filter is a line filter.

45. The method according to claim 43, wherein the pattern is lasered with a constant angle of incidence.
